(19) United States
(12) Patent Application Publication
(10) Pub. No.: US 2021/0261005 A1
(43) Pub. Date: Aug. 26, 2021

(54) Development of Mobile Marine Charging Stations (MMCS)

(71) Applicant: Hossam Gaber, North York, CA (US)

(72) Inventor: Hossam Gaber, North York, CA (US)

(21) Appl. No.: 16/799,321

(22) Filed: Feb. 24, 2020

(51) Int. Cl. B60L 53/10; B60L 53/53; B60L 53/56; B60L 53/66; B60L 53/51; B60L 53/52; B60L 53/62; B60L 53/68; B60L 53/30

(52) U.S. Cl. CPC B60L 53/11; B60L 53/53; B60L 53/56; B60L 53/66; B60L 2200/32; B60L 53/52; B60L 53/62; B60L 53/68; B60L 53/305; B60L 53/51

(57) ABSTRACT

This patent presents the development of Mobile Marine Charging Stations (MMCS) that will be integrated with power utility grids to serve marine transportation infrastructures and applications. MMCS will ensure sustainable and safe operation during normal and emergency conditions. This patent proposes the design of fast charging stations for marine transportation infrastructures and applications where the station would supplement the short-trips and long-trips charging processes. The energy management of the station is performed by an optimization and rule-based algorithm that controls the power flow between the fast chargers, the energy storage system and the grid terminals. The trade-off between the technical and economic benefits is implemented to optimize the size of energy storage system and the power rating of the grid connection, as well as optimize the operation of MMCS. Flywheel is utilized in the design of MMCS due to its kinetic energy storage that offers powerful features.

This patent presents the development of Mobile Marine Charging Stations (MMCS) that will be integrated with power utility grids to serve marine transportation infrastructures and applications such as fishing, ship, ferry, and seaport. MMCS will ensure sustainable and safe operation during normal and emergency conditions. This patent proposes the design criteria of fast charging stations for marine transportation infrastructures and applications where the station would supplement the short-trips and long-trips charging processes. The energy management of the station is performed by a rule-based algorithm that controls the power flow between the fast chargers, the energy storage system and the grid terminals. There is a clear trade-off between the size of energy storage system and the power rating from the grid connection. Flywheel kinetic energy storage offers very powerful features such as the dynamic response and power density. Moreover, considering different-range marines, this technology can be enough to supply the sufficient energy to the marines' power-train.

The challenges to be met is to integrate such technology are the mass, the efficiency and especially the cost. Then, in this patent, a techno-economic optimization of a flywheel energy storage system is presented. The proposed system is made up of a flywheel, a permanent magnet synchronous machine, batteries and power converters. For each part of the system, physical and economical models are proposed. Finally, an economic optimization is done on short-range and long-range ship profiles to maximize ROI of the proposed system.

The patent focuses on the design and implementation of high performance and resilient energy storage systems using integrated battery and flywheel technologies to support and balance energy demand-supply of marine transportation to maximize their overall performance. In addition, the target flywheel-based resilient energy storage platform will support marine transportation electrification infrastructures, and distribution networks, as part of their integration with the power stations with optimized design, reduced operational costs and overall reductions in health-safety-environmental risks. The energy storage management system will provide resilient features to ensure minimum operation interruptions and higher availability using self-healing and fault tolerant control mechanisms that can effectively decide the charging/discharging of the battery units and their integration to the flywheel and loads.

The integration between battery technology and flywheel systems can offer high performance and resilient energy storage platform that can deal with dynamic load profiles, quick and adaptive demand response, and high performance charging/discharging mechanisms.

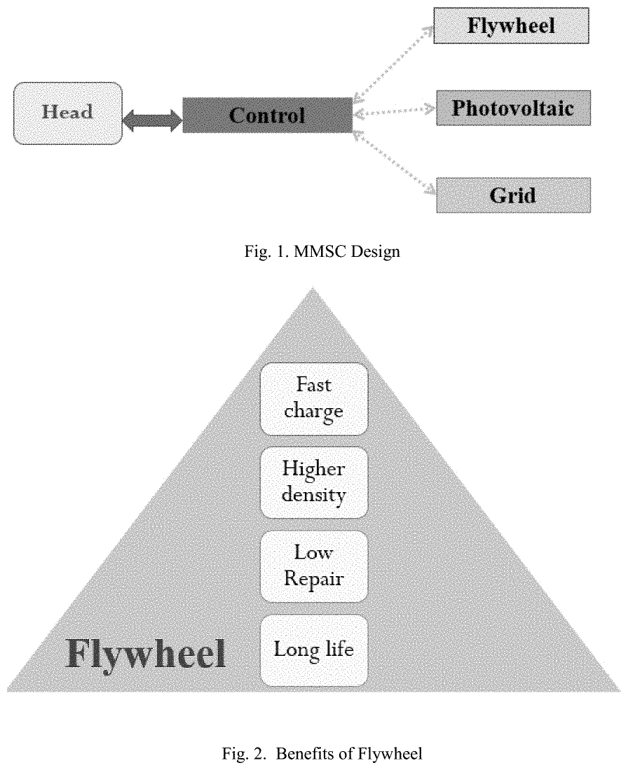

FIG. 1 presents MMCS design, where this patent aims at the implementation of Flywheel-Based Fast Charging System. The structure of the proposed MMCS is that mainly structured from Flywheel Energy Storage Platform (FESP), Resilient Control Architecture (RCA), Fast Charging Controller (FCC), Smart Energy Management and Automation (SEMA), Battery Units (BU), and Control and Communication Signals (C1, C2 . . . ).

FIG. 2 shows the benefits of FESP, where the design and implementation of high performance and resilient energy storage systems is using integrated battery and flywheel technologies to support and balance energy demand-supply differentials to maximize their overall performance.

FIG. 3 shows the design of control circuit for charging/discharging schemes, and

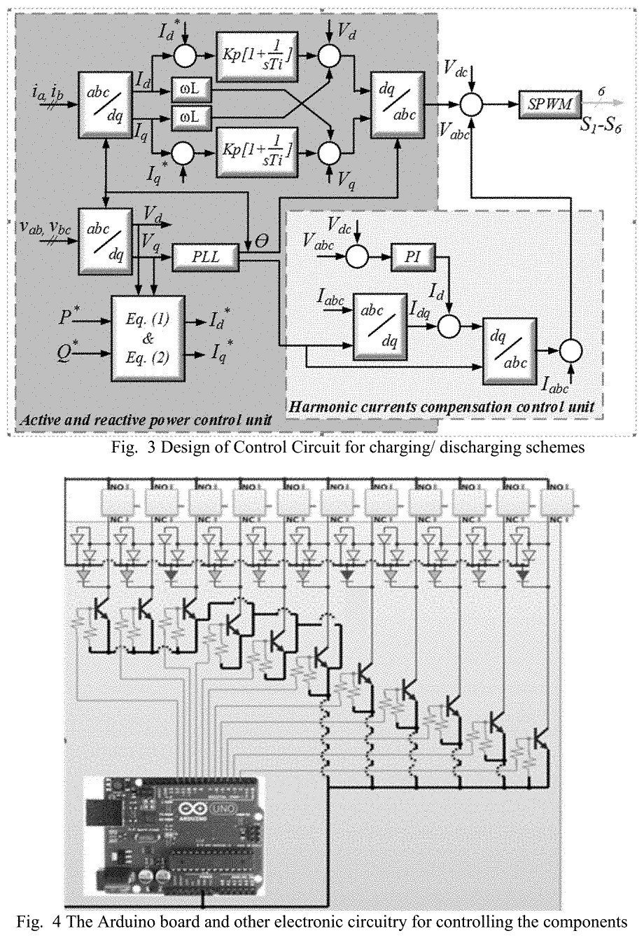

FIG. 4 presents the Arduino board and other electronic circuitry for controlling the components are integrated into one board to reduce the clutter of wire. The flywheel energy storage system can be considered as the unique solution for the grids with peak demand and consumption due to its technical merits for energy profile with advantage of the utilization of the mechanical energy and its conversion to electrical power.

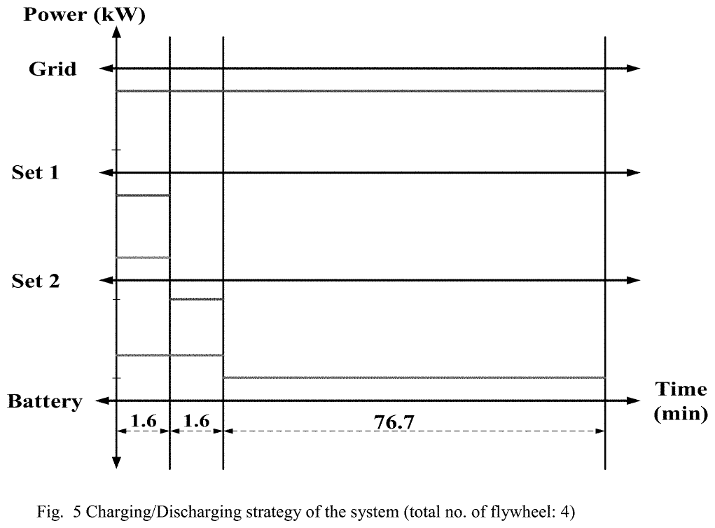

FIG. 5 shows charging/discharging strategy of a system with total no. of flywheel equals 4. So with respect to the customer regulations and demand, the flywheel can achieve the optimal technical and economic solution.

### APPLICATIONS FOR MMCS

The emergent charging for marines at the blackout and the emergency scenarios on marine board to help drivers to stranded without the main power.
Advanced maintenance and troubleshooting for marine.
Resilient operation and applications such as: Fishing, ship, ferry, and seaport.
Backup and safety service and coverage for any health, security and safety conditions for marine manufactures and operators.

The proposed approach is based on the following steps:
Design integrated energy storage models using battery systems and flywheel technologies based on design requirements, load profiles, and other system specifications
Define configuration parameters and optimize for the most suitable operational scenarios
Develop comprehensive economic and technical performance indicators for the design and operation of the proposed integrated system
Evaluate risks and design fault tolerant and self-healing approaches to ensure resilient energy storage systems
Evaluate and optimize the overall performance, including costs, quality, resiliency, and risks with environmental consideration for the potential design alternatives and control scenarios
Design and optimize control architecture with management system for the integrated energy storage platform
Design and demonstration of the integrated energy storage system for a pilot site, which will be applied on number of deployment patents for marine transportation electrification
Assess and review the compliance with the national and international standards and regulations, as well as regional energy policies
Validate and verify the integrated energy storage system, and test and evaluate operational data and tuning of the pilot energy storage platform to quantify performance metrics in preparation for wider deployment and installation

The proposed research presents a novel integrated energy storage platform based on an advanced flywheel and battery technology. The proposed research will include areas where innovations can be performed to enable this vision as follows:
Novel design of energy storage platform to dynamically balance charging power flow and achieving the target demand response, voltage and frequency regulation requirements
Design configuration, control, monitoring, and performance optimization of the proposed integrated MMCS
Development of an integrated architecture for the intelligent control system for the proposed MMCS, including battery units, flywheel systems, and the integration with the grid, considering the balance between supply and demand and economics
Synthesis, evaluation, and optimization of charging/discharging scenarios between grid, flywheel, and battery units with energy efficiency and stability considerations.
Development of a self-healing and fault tolerant techniques and strategies for resilient operation
Evaluate the impacts of energy storage systems on distribution networks, considering uncertainties related to the variation of load demand, outages.
Development of intelligent optimization algorithms to improve system performance, design configuration, efficiency, power availability, flexibility, dispatch ability, energy storage.
Simulation of energy-utilization performance with respect to batteries performance, trip route for marine transportation loads and operation of charging station
Testing report of performance under different operating and weather conditions
Verification and validation of technical aspects of flywheel system, including: vibration, thermal, temperature control
Develop platform for analysing, evaluating, and optimizing the operation with performance indicators for economic and technical operation

The following are the expected technical impacts with potential contributions from this patent:
The patent will support the marine transportation infrastructures for marine operation and maintenance
The patent will support safety and recovery operation in marine due to oil spills or fire that might occur, while in MMCS the only source of energy is energy storage, with battery and flywheel without the need for IC that might be hazardous during fire
The patent will support clean fishing, with reduced GHG from fishing operations
In future we will integrate marine waste-to-energy with energy storage, by converting marine waste into energy and use energy storage for clean energy supply for marine
The patent will support clean marine shipping/cargo with reduced GHG and establish energy charging infrastructures with long term plan to build energy storage infrastructures in off-shore platforms
Benefits for clean tourism using clean marine with proposed sustainable energy systems and energy storage solutions
MMCS will provide stable, clean, cheap energy supply with battery and renewable energy integration for operation of marines facilities
MMCS will provide excess energy back to the grid
MMCS will provide fast charging station with resilient battery management to support energy supply to mechanical/electrical systems and operation of marine facilities and activities on site
MMCS will have resilient intelligent controller for high-performance control with optimization to ensure minimum energy costs, conservation, and high profit and improved ROI
MMCS will provide resilient and self-healing/fault-tolerant functions to ensure sustainable and stable energy supply to operation of marines
MMCS will have optimum system configurations to increase the efficiency, power availability, flexibility, dispatch ability, energy storage.

The following is the scheduled modules and tasks:

A1—Patent planning, management, resources, teams and communications plan.

A2—Study and analysis of demonstration Sites, and communications with Transportation Company for marine demand analysis, including:
Define charging station dynamic performance and different operating conditions, including normal and abnormal operation, and during sever conditions
Select demonstration site for MMCS installation and deployment

A3—Study of energy storages: batteries and flywheel systems, parameters, constraint and operational behaviours, to define energy storage technology and technical requirements

A4—MMCS design requirements and specification analysis to develop MMCS design models and parameters, and to select different demand profiles for MMCS dynamic models

A5—Operational MMCS design, modelling and simulation to synthesize operating scenarios and evaluate MMCS design based on KPIs

A6—MMCS control system requirements, design, and validation by:
Define design specifications of resilient control architecture for MMCS in different operation modes
Develop monitoring criteria for stable and high performance MMCS

A7—MMCS performance optimization by:
Analyse and optimize power stability, quality, voltage, and frequency of MMCS
Develop heuristic/intelligent algorithms to optimize the design, sizing, configuration of MMCS, battery systems, flywheel, and interface systems to the marine infrastructure
Develop intelligent multivariate data analysis techniques to analyse and optimize MMCS performance

A8—MMCS Installation and Testing by:
Install MMCS with marine infrastructure.
Develop interface between MMCS and marine networks with real time operation
Test network-connected and islanded mode of operations under different conditions and scenarios
Study power quality, voltage and frequency stability under different operating conditions and scenarios
Conduct integrated tests

### MMCS Technology for Related Battery Charger

Battery charging technology relies on computer chips (microprocessors) to do the job; this is done in three stages: 1) bulk, 2) absorption and 3) float. The chargers engineered for the staging tasks are referred to as “smart chargers” designed to provide maximum charge benefit with minimum observation. A typical three-stage charging process for a wetted lead acid deep cycle battery works as follows:

1) Bulk Stage: This first stage provides a constant amperage bulk charge, usually of 25-40% of the battery's capacity (in amp hours, Ah) up to about 14.4 volts (14.2 for gel cells). This bulk charge will restore about 75% of the battery's total capacity. It takes less time than other less expensive chargers such as ferroresonant chargers, because the smart charger delivers greater current to the batteries during the time that they can accept greater current loads because of the degree of their discharge.

2) Absorption Stage: The remaining 25% of capacity is restored at a decreasing rate. Maintaining the battery at about 14.4 volts (14.2 for gel), the amperage is steadily reduced. The battery is considered fully charged when it will accept only 2-4% of its amp-hour capacity at 14.4 volts.

3) Float Phase: The charge amperage has declined to 2-4% of the battery's capacity, and voltage drops to a maintenance level which maintains the battery without losing electrolyte from gassing. The charger will increase charge commensurate with discharge when 12 V draw occurs as if from refrigeration, electronics, inverter etc.

4) Equalization: Applies to lead-acid batteries only. This fourth, manually triggered stage, prevents lead-acid batteries from aging prematurely by applying a small, constant current until the battery reaches a relatively high voltage, (often around 16 volts) which removes the hardened lead sulfate crystals on the battery plates and prolongs battery life. During the equalization process all DC users should be turned off to avoid damage from high voltage. The liquid in the battery will emit small bubbles. It is “gassing.” This requires very good ventilation during the process and the liquid level should be checked and topped up after the process. While most chargers automatically cut off after a pre-programmed point in the equalization phase, their instructions also typically recommend checking the specific gravity of each battery cell to assure proper equalization. This process, as you can see, requires careful following of the instructions and other safety measures. There are two types of chargers to consider: portable and onboard.

Portables are great for many applications—especially when batteries are at home and/or if they are out of the boat. These chargers also tend to be a bit less expensive then onboard models. The primary disadvantage of portable chargers is that they can be somewhat inconvenient to hook up and switch from battery to battery in the confines of a boat's battery compartment. And because they are portable, they are more subject to being stolen if we need to use them in places like motel parking lots, boat stalls or other public places.

Onboard chargers, although more expensive, can easily help pay for themselves when it comes to convenience. Since the whole system is already wired, simply plug it in to a 120-volt outlet and let the charger do the work; because it's permanently installed, it certainly deters would-be thieves. On-board chargers are generally more technologically-advanced units, providing the necessary multi-stage switching to manage and maintain a boat's batteries during charging.

### MMCS Charging Size

Charger size ranges from 10% up to 25% of the battery's amp-hour rating. The higher the charger ampere rating, the quicker the recharge time is. Recharge time can be approximated by using a fairly simple formula: Divide the number of amp-hours to be replaced by 90% of the rated output of the charger.

Example: we have a 100 amp-hour battery that has been discharged by roughly 50 percent. Therefore it is needed to replace 50 amp-hours. Using a 10-amp charger, take 50 amp-hours and divide by 90% of 10 amps (or 9 amps)=an approximate 5.6 hour recharge time. A deeply discharged battery deviates a bit from this formula, requiring more time per amp-hour to be replaced. A 6-amp charger would require over 9 hours, while a 15-amp charger would take less than 4 hours to replace the 50 amp-hours of charge.

### Different MMCS Types of Electric Charging Station

1 Integrated with Solar Charge Station

Charging one's Electric Boat, Scooter, Snow-craft or any other Electric Vehicle at his own solar charge station. One can set up this small station anywhere with no need for electric power service. This affordable system consists of a 12V Solar Panel, a 12V Deep-Cycle Station Battery and a Controller. The controller charges station battery and produces 115 VAC (or 230 VAC) for the scooter charger. Further, an optional Remote Link informs the owner of station or vehicle charge troubles.

### Specifications:

Solar Panel: nominal 12V, 80 to 100 W (size usually 32″×20″)
Optional Line Back-up: Input from a 16 VAC-75 W class 2 transformer
Station Battery: 12V at least 100 AH (group 29 Marine deep cycle)
Station Controller: A microprocessor based Charge controller for station battery charge as well as producing 115 VAC or 230 VAC (specify which) at its output plug.
Output: Standard 3-prong AC outlet; 115 VAC 1 A max or 230 VAC 0.5 A max
LED Indications on the Controller: Sunny and Station battery Charging (Green), Station Battery Low (Red), Scooter Plugged (Amber) and Scooter Charging Complete (RED).
Charge Switch: Toggle switch to enable AC power to scooter's own charger unit
Remote Report: A closed contact reports station trouble; Station Battery Low or incomplete scooter charge interruption. It can be connected to a remote LED Lamp or buzzer.

### Solar Charge Controller:

The solar charge controller is what converts the power coming from the panel into power that can be used to efficiently charge the battery. If the panel voltage is higher than the battery voltage, then a step-down controller with the proper ratings is required for array. If the panel voltage is less than the battery voltage, then a boost controller is needed.

2 Integrated with Wind Generator Charge Station

Many people also use wind generators to keep their 12 volt system charged. Solar cells generally have less output for the money than wind generators and require special mounting racks or cabin or bi-mini top space. Wind generators can usually put out more current, but only if the wind is up. They make noise, which some find objectionable but others find soothing. Usually people become accustomed to it. Great care must be taken to avoid being hit by a propeller and also to shut it down when the wind gets too high. Better wind generators have a self-contained automatic dampening mechanism to prevent over-speed in high winds. One or both systems are often used by those who don't consume much electricity or who want to keep their batteries up while they're off the boat, particularly as when there's no dock power available as when they're at anchor or on a mooring. Even with these systems an overcharge protection must be provided. Devices that do this usually come with the wind generator or solar cell.

### MMCS Features:

Charges 12V battery plus 24 or 36 v Auxiliary (up to 4 batteries)
Works with all battery types—Lead Acid, GEL, AGM, Lithium
Charges on the run
Automatically balances and equalizes batteries
Complete battery maintenance—leave plugged-in—monitors automatically
Built-in Emergency Engine Start
Automatic bi-directional power distribution between cranking and auxiliary batteries
Minimum battery levels settings—always have enough juice to start your motor
Wirelessly communicates via C-Monster or Bluetooth
Works with smart phones and VISION for instant real-time battery status visualization of battery levels and power flow

### MMCS Safety Features

UL1236 safety listing
Reverse polarity protection for each battery
Low voltage and overvoltage protection
Over current protection on all output channels
Temperature sensors based on battery chemistry
Short circuit protection

### MMCS Specifications:

The MMCS specifications can be designed to meet the target marine systems. The following are typical ratings of marine systems that can be supported by MMCS:
Up to 500 watts of power—for faster recovery time
Max 40 amps to the cranking battery
Max 25 amps to the auxiliary batteries
Max 500 W 12V engine battery charge from shore power
Max 500 W 24/36V “run charge” from 12V engine battery and/or shore power to auxiliary battery
Max 500 W 12V “back charge” from auxiliary 24/36V battery to engine battery
Waterproof case (IP67)
Weight: 8.75 lbs
Dimensions: Length 10.62″, Width 7.95″, Height 2.78″
3-Year Warranty

1: Novel design of mobile energy storage platform to dynamically balance charging power flow and achieving the target demand response, voltage and frequency regulation requirements

2: MMCS has a resilient self-healing and fault tolerant control technique based on hysteresis loop strategy to provide fast charging station with resilient battery management and to support energy supply to mechanical/electrical systems and operation of marine facilities and activities on site

3: Development of an integrated architecture for the intelligent management system (using raspberry Pi3 B+) for the proposed MMCS, including battery units, flywheel systems, and the integration with the grid, considering the balance between supply and demand and economics.

4: Resilient optimization platform for charging/discharging scenarios between grid, flywheel, and battery units with energy efficiency and stability considerations.

5: Remote and online control and performance monitoring of the proposed integrated MMCS. In addition, integrated graphical user interface (GUI) for smooth user control and setting.

6: MCSS has an intelligent rule-based processors for the safety and recovery operation in marine due to oil spills or fire that might occur, to keep MMCS the only source of energy with the energy storages of battery and flywheel without the need for IC that might be hazardous during fire.
